(19) United States
(12) Patent Application Publication
(10) Pub. No.: US 2015/0256445 A1
(43) Pub. Date: Sep. 10, 2015

(54) AVOIDING GRATUITOUS ADDRESS RESOLUTION PROTOCOL AND UNSOLICITED NEIGHBORHOOD DISCOVERY DURING HOST MOBILITY EVENTS

(71) Applicant: Cisco Technology, Inc., San Jose, CA (US)

(72) Inventors: Nalinaksh Pai, San Ramon, CA (US); Jesper Skriver, San Jose, CA (US)

(73) Assignee: Cisco Technology, Inc., San Jose, CA (US)

(21) Appl. No.: 14/196,659

(22) Filed: Mar. 4, 2014

(51) Int. Cl. H04L 12/721

(52) U.S. Cl. CPC H04L 45/14

(57) ABSTRACT

Systems and methods are described for maintaining communication between hosts that, due to the roaming of a host, are no longer in the same LAN segment within a network. In one embodiment, the method includes receiving an address resolution request from the first host, the address resolution request requesting an actual media access control (MAC) address associated with an internet protocol (IP) address of the second host, obtaining the actual MAC address of the second host, the second host having roamed from away from a first network location where a first host is located, receiving a data packet from the first host that is to be delivered to the second host, and routing the data packet to the second host at its current location, the current location of the second host being determined by its actual MAC address.

### TECHNICAL FIELD

The present disclosure relates to seamlessly maintaining communication between host devices that roam from one local area network (LAN) segment to another.

### BACKGROUND

Next generation campus networks will have the capability of handling an increasing number of mobile devices. These mobile devices acquire one or more Internet Protocol (IP) addresses when they associate with an access point for the first time and expect to be able to retain these IP addresses as they roam around campus both intra-point of delivery (POD) and inter-POD. The retention of the original IP addresses is an important part of the seamless mobility user experience as it allows for existing sessions to remain intact.

What is needed is a method of maintaining communication between hosts when a host roams from one local area network (LAN) segment to another LAN segment yet remains in the other hosts' IP subnet that overcomes the shortcomings of present methods.

### BRIEF DESCRIPTION OF THE DRAWINGS

There are shown in the drawings embodiments that are presently preferred it being understood that the disclosure is not limited to the arrangements and instrumentalities shown, wherein:

FIG. 1 is a computer network that may incorporate one or more exemplary embodiments of the present disclosure;

FIG. 2 is a network node that may incorporate one or more exemplary embodiments of the present disclosure;

FIG. 3 is a network that may incorporate one or more exemplary embodiments of the present disclosure;

FIG. 4 is a database illustrating the binding of IP addresses with MAC addresses for hosts in a network according to one or more exemplary embodiments of the present disclosure;

FIG. 5 is a series of steps performed according to one or more exemplary embodiments of the present disclosure; and

FIG. 6 is a series of steps performed according to another embodiment of the present disclosure.

### DESCRIPTION OF EXAMPLE EMBODIMENTS

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview

In one aspect of the present disclosure, a method of maintaining communication between a first host and a second host within a network is disclosed. The method includes receiving an address resolution request from the first host, the address resolution request requesting an actual media access control (MAC) address associated with an internet protocol (IP) address of the second host, obtaining the actual MAC address of the second host, the second host having roamed from away from a first network location where a first host is located, receiving a data packet from the first host that is to be delivered to the second host, and routing the data packet to the second host at its current location, the current location of the second host being determined by its actual MAC address.

In another aspect, a router is disclosed where the router includes a processor, a network interface, and at least one memory device storing instructions that, when executed by the processor, cause the processor to determine an actual media access control (MAC) address of a second host, the second host having roamed away from a first network location where a first host is located. The network interface is adapted to receive an address resolution request from a first host, the address resolution request requesting the MAC address of the second host, receive a data packet from the first host that is to be delivered to the second host, and route the data packet to the second host at its current location, the current location of the second host being determined by its actual MAC address.

In yet another aspect, a non-transitory computer-readable storage medium having computer-executable instructions for maintaining communication between a first host and a second host within a network is disclosed. The instructions, when executed by a computer, cause the computer to receive an address resolution request from the first host, the address resolution request requesting an actual media access control (MAC) address associated with an internet protocol (IP) address of the second host, obtain the actual MAC address of the second host, the second host having roamed from away from a first LAN segment where the first host is located, the first host and the second host having IP addresses in the same IP subnet, and route a data packet received from the first host to the second host at its current location, the current location of the second host being determined by its actual MAC address.

### DETAILED DESCRIPTION

A computer network is a geographically distributed collection of nodes interconnected by communication links and segments for transporting data between end nodes, such as personal computers and workstations. Many types of networks are available, with the types ranging from local area networks (LANs) to wide area networks (WANs). LANs typically connect the nodes over dedicated private communications links located in the same general physical location, such as a building or campus. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

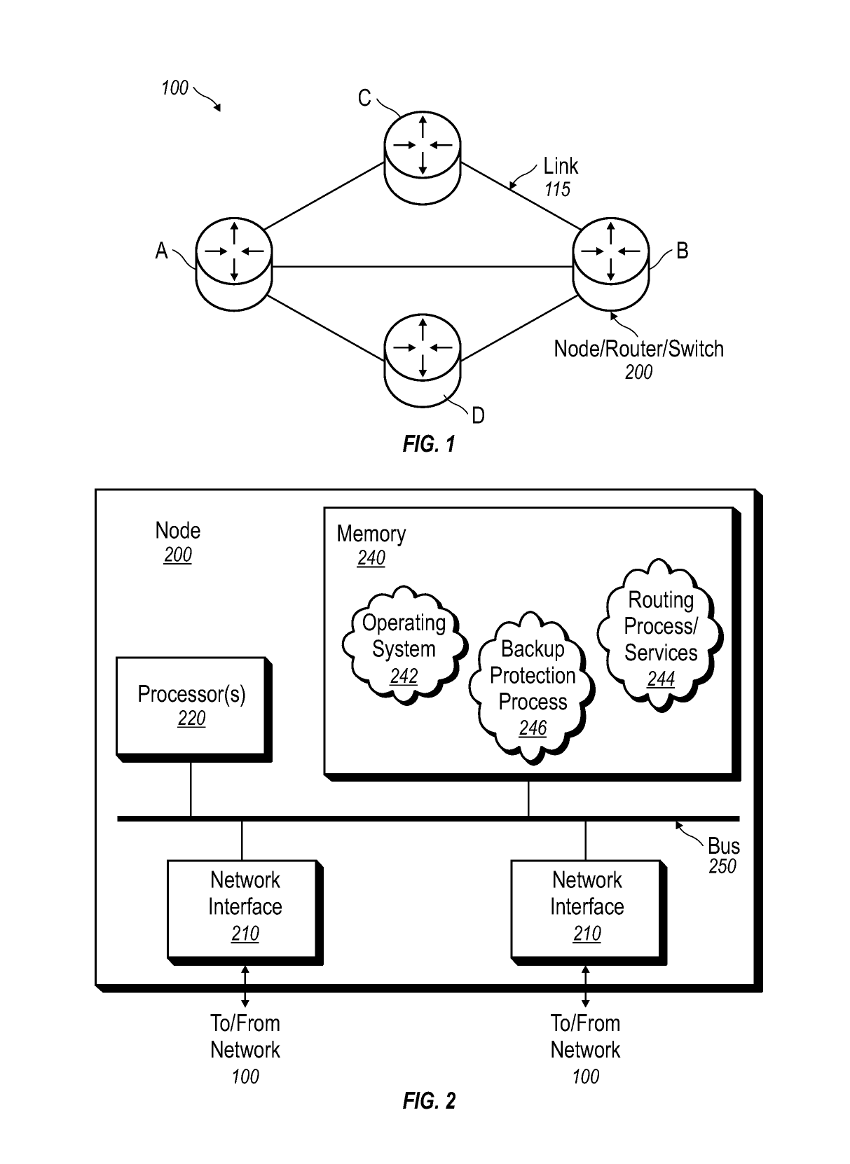

FIG. 1 illustrates an example computer network 100 illustratively comprising network nodes, such as switches or routers 200 (e.g., switches/routers A-D) interconnected by communication links 115. As used herein, the communication links may be labeled by their corresponding endpoints, such as the link between nodes B and D being referred to herein as “link BD” (or equally “link DB”). Those skilled in the art will understand that any number of nodes, devices and/or links may be used in the computer network, and that the view shown herein is for simplicity.

FIG. 2 illustrates an example network node 200 that may be used with one or more embodiments described herein. Network node 200 may be any suitable combination of a switch, a router, and any other suitable network device. Network node 200 may comprise a plurality of network interfaces 210, one or more processors 220, and a memory 240 interconnected by a system bus 250. Network interfaces 210 contain the mechanical, electrical, and signaling circuitry for communicating data over physical links coupled to the network 100. Network interfaces 210 may be configured to transmit and/or receive data using a variety of different communication protocols, including, inter alia, Transmission Control Protocol/Internet Protocol (TCP/IP), User Datagram Protocol (UDP), Asynchronous Transfer Mode (ATM), synchronous optical networks (SONET), wireless protocols, Frame Relay, Ethernet, Fiber Distributed Data Interface (FDDI), etc. Notably, a physical network interface 210 may also be used to implement one or more virtual network interfaces, such as for Virtual Private Network (VPN) access, known to those skilled in the art.

Memory 240 comprises a plurality of locations that are addressable by processor(s) 220 and network interfaces 210 for storing software programs and data structures associated with the embodiments described herein. Processor 220 may comprise necessary elements or logic adapted to execute the software programs and manipulate the data structures. An operating system 242 (e.g., the Internetworking Operating System, or IOS®, of Cisco Systems, Inc.), portions of which are typically resident in memory 240 and executed by the processor(s), functionally organizes the node by, inter alia, invoking network operations in support of software processes and/or services executing on network node 200. These software processes and/or services may comprise routing process/services 244 and backup protection process 246 that may, for example, facilitate maintaining communication between hosts in a network when one or more hosts roam to a different network location. It will be apparent to those skilled in the art that other types of processors and memory, including various computer-readable media, may be used to store and execute program instructions pertaining to the techniques described herein. Also, while the embodiments herein are described in terms of processes or services stored in memory, alternative embodiments also include the processes described herein being embodied as modules consisting of hardware, software, firmware, or combinations thereof.

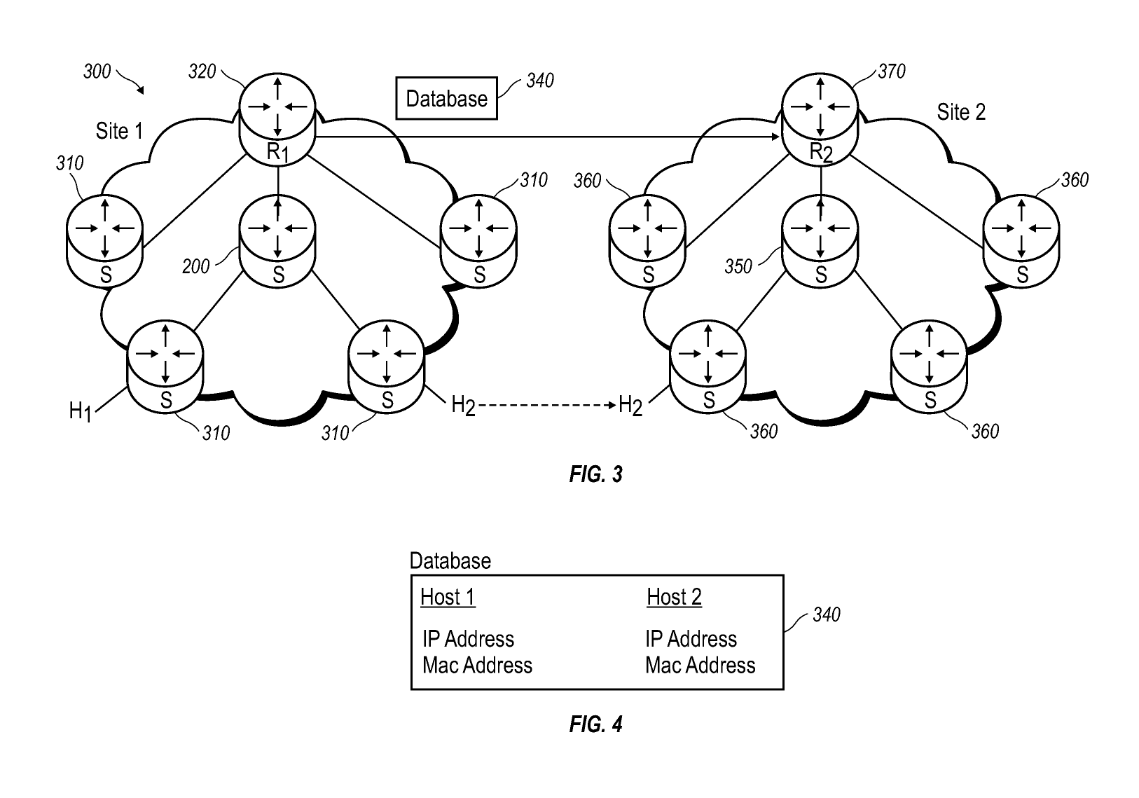

FIG. 3 is an illustration of a network incorporating exemplary embodiments of the present disclosure, that include maintaining communication between a first host and a second host when the second host roams to a network location that is different from the network location of the first host. In this embodiment, a first site, Site 1, represents a network location such as a LAN segment within a network 300. Network 300 can be any computer network, for example, an IP subnet located in a building on a high school or college campus, or a floor within an office building. Site 1 includes a series of switches 200, including access switches 310, and a router R1 320. The configuration of switches 200 and 310 in FIG. 3 are exemplary only. For example, each network can include any number of switches 200, including access switches 310, routers 320 and other nodes.

Access switches 310 can be connected to one or more host devices. These host devices, represented by H1 and H2, can be any computer or computer devices that offer resources, service and/or applications to other nodes or users in network 300. Hosts H1 and H2 can be hard-wired to the switches and thus unable to move from one site to another. However, if either host is a wireless host, the host can roam to a different network location. Thus, for example, host H2 can roam to a different LAN segment, Site 2, thus ending up in a LAN segment that is different from the LAN segment that host H1 is currently part of (Site 1). While host H1 and host H2 may still be part of the same network 300 or IP subnet, communication between the two hosts will be lost because host H2, while maintaining its assigned IP address, has now roamed to a different LAN segment, Site 2, from which it was originally associated. Site 2 is a different LAN segment and may also contain one or more switches 350 including one or more edge access switches 360, and one or more routers R2 370.

In one embodiment, host H1 wishes to send data packets to host H2. In this example, host H1 knows the IP address of host H2 and still believes host H2 remains in Site 1, even though host H2 has roamed to Site 2. “IP address” in the context of the present disclosure may include, for example, IPv4 and/or IPv6 addresses. Host H1 may obtain the IP address of host H2 via domain name system (DNS) or other traditional means. Host H1 may then determine if H2's IP address is within the same subnet as its own IP address. If this is the case, host H1 assumes that H2 is located within the same LAN segment. In this instance, host H1 wants to continue to send data packets to H2, assuming host H2 is still within the same LAN segment as host H1. Host H1 may consult its own ARP/ND table in order to obtain host H2's MAC address. If host H1's ARP/ND table does not provide the MAC address of host H2, host H1 sends out an ARP/ND request in order to obtain it.

Router R1 320, via network interface 210, intercepts the ARP/ND request, and, via processor 220, consults a central database 340, which has been updated to store not only each host's IP address but also each host's actual MAC address. Router R1 320 searches for the IP address of the roaming host, obtains its corresponding MAC address, and, via network interface 210, replies to the ARP/ND request, informing host H1 of H2's actual MAC address. Additionally or alternately, router R1 320 can, via network interface 210, unicast the ARP/ND request to host H2 in order to solicit a reply from host H2. Now that host H1 has obtained the MAC address of host H2, data packets sent by host H1 for host H2 (with a destination MAC address being host H2's actual MAC address) are picked up by router R1 320, which routes the data packet from host H1 to the current location of H2 at its current MAC address.

For example, host H1 is to send data packets to host H2. Host H1 believes that host H2 also resides in Site 1 since host H2's IP address is in the same IP subnet as host H1's IP address. Host H1 sends out an address resolution request to host H2. The request is ultimately received by router R1 320 via switch 200. This address resolution request can be, for example, an ARP request or a neighbor solicitation. Router R1 320 can access a central database 340, which has stored the IP addresses of each host within the network. According to one embodiment, central database 340 also binds the actual MAC address of each host to its IP address (as shown in FIG. 4). After accessing this information in database 340, router R1 320 may now generate a reply to the address resolution request where the reply contains the actual MAC address of host H2 (which is no longer in Site 1) and forward the reply to the querying host, host H1. At this point, host H1 has obtained the MAC address of host H2 and can send L2 data frames with a destination MAC address of host H2. Router R1 320 can intercept these frames and L3 route the frame to the current location of host H2.

In another embodiment, rather than reply to the address resolution request with a reply that includes the actual MAC address of the host that roamed, router R1 320 accesses database 340 to determine the network location of host H2 and then uses this information to forward the address resolution request to router R2 370, which is the router at the network location (Site 2) where host H2 has roamed to. Router R2 370 then forwards the address resolution request to host H2, now located in Site 2, and relays the reply from host H2 back to host H1. Having learned of Host H2's actual MAC address, host H2 can direct frames to the roaming host H2 in the manner described above.

By using one of the two methods described above, each host in the network can learn the actual MAC address of other hosts in the network, and store within its L2 neighbor cache the actual MAC address of all of the other hosts in the network. This may reduce of eliminate the need for each host to update its cache every time a host moves from one LAN segment to another.

Data packets sent from host H1 need to be routed to host H2 even though host H2 now resides in a different LAN segment but still shares the same IP subnet as host H1. One way of accomplishing this is to ensure that L2 data packets sent from one host are delivered to the local router of the LAN segment rather than to the port which the host that roamed away from the LAN segment used to connect to. In this embodiment, when a host roams away from a LAN segment, the router in that LAN segment sends, via network interface 210, an L2 broadcast frame into the LAN segment that has a source MAC address of the host that roamed away. This may ensure that L2 switches in the LAN segment will stop forwarding packets to the host that roamed away and instead forward the packets to the router. For example, as shown in FIG. 3, host H2 has roamed from Site 1 to Site 2. If host H1 continues to send data packets to host H2 after host H2 has roamed to a different LAN segment (Site 2), communication will be lost. However, in this embodiment, after accessing database 340 to obtain the current MAC address of host H2, router R1 320 sends an L2 broadcast frame to the L2 switches (200, 310) within its LAN segment (Site 1). The broadcast frame includes a source MAC address of host H2, which has roamed to Site 2. This broadcast ensures that L2 switches (200, 310) within Site 1 will stop forwarding data packets addressed to host H2's MAC address to the port it was connected on. Instead, the L2 switches in Site 1 will forward data packets towards router R1 320 because the broadcast frame sent by router R1 320 included the source MAC address of host H2.

In the absence of traffic having a source MAC address of host H2, the forwarding entries in the L2 switches (200 and 310) of Site 1 for the MAC address of host H2 will eventually age out, causing the L2 switches in Site 1 to flood data packets destined to the MAC address of host H2, which might result in an unknown unicast. This can be addressed in several ways. In one exemplary embodiment, router R1 320 periodically refreshes the L2 forwarding entries for the L2 switches of Site 1 by sending a broadcast frame with a source MAC address of the host that roamed away from Site 1, e.g., host H2. In another exemplary embodiment, the L2 forwarding entries in the L2 switches can be programmed to be static in order to prevent them from aging. In yet another exemplary embodiment, unknown unicast flooding in the L2 switches are disabled for data packets received on any port except the ports connected to the routers. Instead, all unknown unicasts are forwarded to the attached router(s). This router then routes the data packet according to its destination IP address. In the instance where a host that is attached to the LAN segment the packet arrived on but has been silent for so long that the L2 forwarding entries have timed out, the router can route the packet back onto the LAN segment, and as the packet is now received on a router port on the L2 switch, it will flood it on all downstream ports and the destination will receive the packet. Once it sends a reply, the L2 forwarding entries in the L2 switches will be updated. If the LAN segment is used for non-IP traffic, this could be made conditional on the ethertype being “IP”.

Another method of ensuring that data packets are routed between hosts that are no longer in the same LAN segment is for router R1 320 to IP-route the packet despite the destination MAC address not being the router's MAC address. This can be done by putting the router R1 320 in an L2 promiscuous mode such that an L2 frame of relevant ethertype sent from a switch within Site 1 will be IP-routed instead of bridged. In this fashion, data frames sent by Host H1 destined for Host H2 via switches 200 and 310 will instead be sent to router R1 320 and then sent to router R2 370 in Site 2, where host H2 is located. Alternately, the destination MAC address of the roaming host (host H2) can be rewritten to be the MAC address of router R1 320, so that the data packets destined for host H2 are directed towards router R1 320, which will IP-route the data packets to the LAN segment where host H2 now resides (Site 2). This reconfiguring of the MAC address of the roaming host H2 to the MAC address of the router R1 320 can be done, for example, by the L2 switch (e.g. 200 or 310) when sending the packet to router R1 320 or by router R1 320 when receiving the data packet from the L2 switch.

FIG. 4 represents a database 340 that stores the IP address of each host in the network. According to an exemplary embodiment, database 340 stores the IP addresses of each host in the network. Although FIG. 4 lists only two hosts, Host1 and Host2, the database can store the IP addresses of any number of hosts in the network. As described above, database 340 can be used in one of two ways to facilitate the answer to an address resolution request when the location of one or more hosts in the network is desired. According to an exemplary embodiment, database 340 is advantageously extended to also include an attribute that contains the actual MAC address and the current network location of each host. Thus, in certain embodiments, database 340 essentially binds the IP address of each host in the network with its MAC address and network location. Thus, a node in the network that has access to database 340 can refer to database 340 in order to obtain the current MAC address of any host, and its current location within the network. This information can be included in a reply to an address resolution request sent back to a querying node.

In another exemplary embodiment, a node in the network such as a first hop router can use database 340 to determine the network location of a host that, for example, has roamed from Site 1 to Site 2, as in FIG. 3. The router (e.g., R1 320) can access database 340 and obtain the actual MAC address of the host that roamed. Router R1 320 can then forward the address resolution request to a router (e.g., R2 370) located at the network location that contains the destination host. The router (R2 370) then forwards the address resolution request to the host that has roamed (e.g., H2), and forwards the reply back from host H2 to the querying host (host H1). Now that host H1 has learned the actual MAC address of host H2, it can update its ARP/ND cache to include the MAC address of the roaming host, H2. Thus, each host in the network can obtain and store the current MAC address of other hosts in the network. In this fashion, communication between hosts, even if they are located in different LAN segments within an IP subnet, can be maintained without the need to update the ARP/ND tables for all hosts each time a host moves to a different LAN segment.

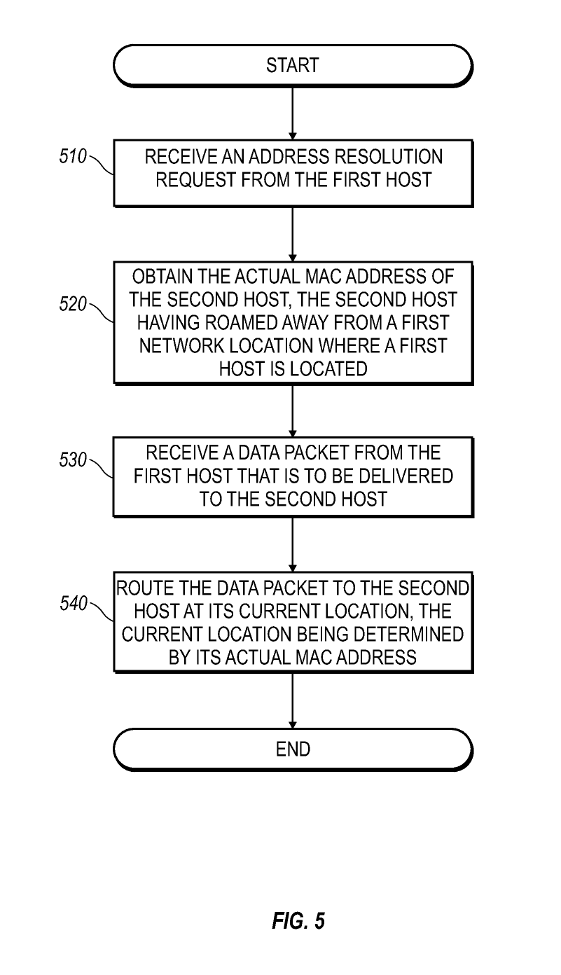

FIG. 5 illustrates steps taken by an embodiment of the present disclosure, for example by router R1 320 in network 300. Because host H1 is to send data frames to host H2 and believes host H2 to be in its own LAN segment, host H1 sends to Router R1 320 an address resolution request (step 510). Router R1 320 accesses database 340 in order to obtain the actual MAC address of host H2, which has roamed from Site 1 to Site 2 (step 520). Once it has been determined that host H2 has moved and is now in a different LAN segment, data packets from host H1 destined for host H2 are received by router R1 320 (step 530). Otherwise the data packets would not reach host H2, which has roamed away from Site 1. As described above, this can be accomplished by router R1 320 sending a broadcast frame to switches 200 and 310 where the broadcast frame includes as a source address, the MAC address of host H2. This will serve to “attract” data frames to router R1 320. Router R1 320, which having obtained the actual MAC address of host H2 now knows the current location of host H2. Thus, router R1 320 routes the data packets received from host H1 to host H2 which currently resides in Site 2 (step 540). Router R2 370, which is the router located in the network location (Site 2) where host H2 now resides can receive the data packets and route them to host H2.

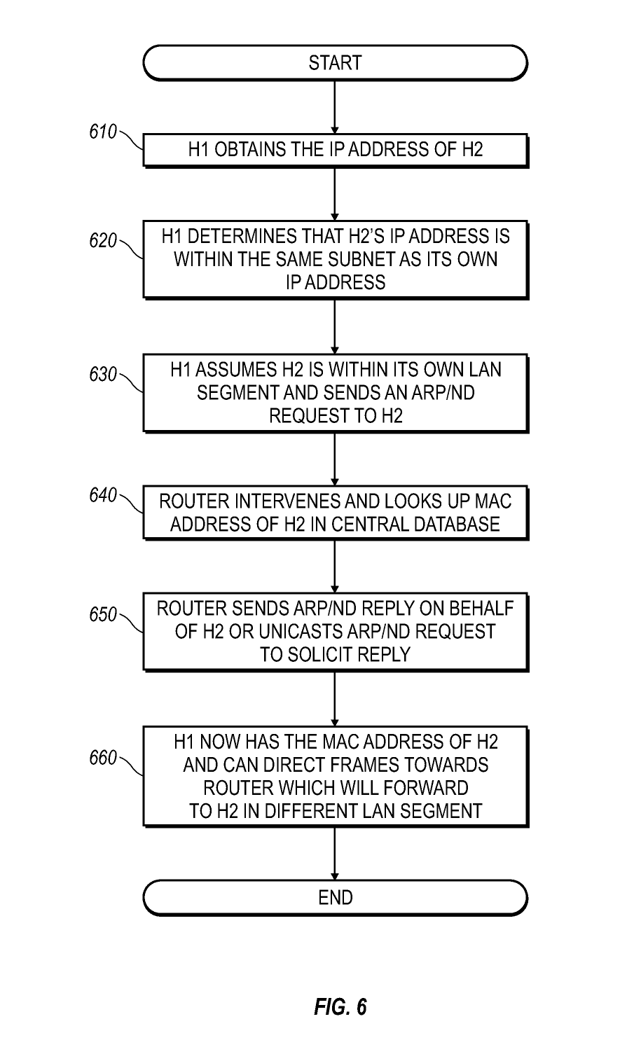

FIG. 6 illustrates another embodiment of the steps taken by the present disclosure. Host H1 obtains the IP address of host H2 (step 610) and determines that the IP address of host H2 is within the same subnet as the IP address of host H1 (step 620). Host H1 assumes that host H2 is within its own LAN segment and sends an ARP/ND request to host H2, seeking the actual MAC address of host H2 (step 630). Router R1 320 intervenes and accesses database 340 (step 640), which has been updated to obtain the actual MAC addresses of all hosts in the network. Router R1 320 can then either send a reply to the ARP/ND request on behalf of host H2 or unicast the ARP/ND request to host H2, in order to solicit a reply from host H2 (step 650). The actual MAC address of host H2 is included in the reply. Thus, host H1 now has the actual MAC address of host H2. Data frames from host H1 destined for host H2 are intercepted by router R1 320, which forwards the data frames to host H2, which has roamed to Site 2 (step 660).

As described above, to ensure that router R1 320 receives and routes the data packets destined for host H2, router R1 320 can be put in a promiscuous mode which ensures that data packets will be IP-routed instead of bridged. In another embodiment, the destination MAC address of the data packets are rewritten to be the MAC address of router R1 320 rather than the MAC address of host H2. This can be performed by either an L2 switch when sending the data packets to router R1 320 or by router R1 320 when it has received the data packets from the L2 switch.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

Various embodiments discussed or suggested herein can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

The operating environments disclosed herein can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of various aspects of the disclosure as set forth in the claims.

We claim:

1. A method comprising:
receiving an address resolution request from a first host, the address resolution request requesting an actual media access control (MAC) address associated with an internet protocol (IP) address of a second host;
obtaining the actual MAC address of the second host, the second host having roamed from away from a first network location where the first host is located;
receiving a data packet from the first host that is to be delivered to the second host; and
routing the data packet to the second host at its current location, the current location of the second host being determined by the actual MAC address of the second host.

2. The method of claim 1, wherein the actual MAC address of the second host is stored in a database that binds the IP address of the second host with the actual MAC address of the second host.

3. The method of claim 1, further comprising transmitting a broadcast frame to one or more switches in the first network location, the broadcast frame including a source MAC address, the source MAC address being the actual MAC address of the second host.

4. The method of claim 1, further comprising:
forwarding, to the first host, a reply to the address resolution request, the reply including the actual MAC address of the second host.

5. The method of claim 1, further comprising:
forwarding the address resolution request to the second host at its current location.

6. The method of claim 1, further comprising changing a destination MAC address of the data packet from the actual MAC address of the second host to a MAC address of a router in order for the router to receive the data packet from the first host.

7. A router comprising:
a processor;
at least one memory device storing instructions that, when executed by the processor, cause the processor to:
determine an actual media access control (MAC) address of a second host, the second host having roamed away from a first network location where a first host is located; and
a network interface adapted to:
receive an address resolution request from a first host, the address resolution request requesting the MAC address of the second host;
receive a data packet from the first host that is to be delivered to the second host; and
route the data packet to the second host at its current location, the current location of the second host being determined by its actual MAC address.

8. The router of claim 7, wherein the actual MAC address of the second host is stored in a database, the database binding the actual MAC address of the second host with the IP address of the second host.

9. The router of claim 7, wherein the network interface is adapted to transmit a broadcast frame to one or more switches in the first network location, the broadcast frame including a source MAC address, the source MAC address being the actual MAC address of the second host.

10. The router of claim 7, the processor further adapted to change a destination MAC address of the data packet from the actual MAC address of the second host to a MAC address of the router.

11. The router of claim 7, the network interface adapted to forward to the first host, a reply to the address resolution request, the reply including the actual MAC address of the second host.

12. The router of claim 7, the network interface adapted to forward the address resolution request to the second host at its current location.

13. A non-transitory computer-readable storage medium having computer-executable instructions, that, when executed by a computer, cause the computer to:
receive an address resolution request from a first host, the address resolution request requesting an actual media access control (MAC) address associated with an internet protocol (IP) address of a second host,
obtain the actual MAC address of the second host, the second host having roamed from away from a first LAN segment where the first host is located, the first host and the second host having IP addresses in the same IP subnet; and
route a data packet received from the first host to the second host at its current location, the current location of the second host being determined by its actual MAC address.

14. The non-transitory computer readable storage medium of claim 13, wherein the actual MAC address of the second host is stored in a database that binds the IP address of the second host with the actual MAC address of the second host.

15. The non-transitory computer readable storage medium of claim 13, wherein the computer-executable instructions further cause the computer to:
transmit a broadcast frame to one or more switches in the first network location, the broadcast frame including a source MAC address, the source MAC address being the actual MAC address of the second host.

16. The non-transitory computer readable storage medium of claim 13, wherein the computer-executable instructions further cause the computer to:
forward, to the first host, a reply to the address resolution request, the reply including the actual MAC address of the second host.

17. The non-transitory computer readable storage medium of claim 13, wherein the computer-executable instructions further cause the computer to:
forward the address resolution request to the second host at its current location.

18. The non-transitory computer readable storage medium of claim 13, wherein the computer-executable instructions further cause the computer to:
change a destination MAC address of the data packet from the actual MAC address of the second host to a MAC address of a router in order for the router to receive the data packet from the first host.

19. The non-transitory computer readable storage medium of claim 13, wherein the computer-executable instructions further cause the computer to:
configure a router in the first LAN segment to be in a promiscuous mode to ensure that the router will route the data packet to the second host at its current location.

20. The non-transitory computer readable storage medium of claim 13, wherein the computer-executable instructions further cause the computer to:
refresh forwarding entries of one or more switches in the first LAN segment by sending a broadcast frame to the one or more switches, the broadcast frame having as its source MAC address, the MAC address of the second host.
